(19) United States
(12) Patent Application Publication
(10) Pub. No.: US 2022/0149554 A1
(43) Pub. Date: May 12, 2022

(54) PRE-LOADED COMPRESSION CONTACT

(71) Applicant: AVX Corporation, Fountain Inn, SC (US)

(72) Inventor: Brent Lybrand, Fountain Inn, SC (US)

(21) Appl. No.: 17/516,306

(22) Filed: Nov. 1, 2021

Related U.S. Application Data
(60) Provisional application No. 63/112,713, filed on Nov. 12, 2020.

(51) Int. Cl. H01R 13/24; H01R 43/16; H01R 12/71; H01R 43/26

(52) U.S. Cl. CPC H01R 13/24; H01R 43/26; H01R 12/714; H01R 43/16

(57) ABSTRACT

An electrical contact includes a base having a first edge and a second edge opposite the first edge. The base is configured to electrically connect with a first electrical component. The electrical contact also includes a first section extending from the first edge and a second section extending from the second edge and including a contact portion to electrically connect with a second electrical component. The second section further includes a pre-load shelf configured to engage with the first section to electrically connect the first electrical component to the second electrical component.

### CROSS REFERENCE TO RELATED APPLICATIONS

The present application claims priority to U.S. Provisional Patent Application No. 63/112,713 filed on Nov. 12, 2020, the content of which is incorporated herein in its entirety.

### FIELD

The present application relates generally to the field of electrical connectors, and more particularly to a type of connector used to electrically connect one electrical component to another electrical component.

### BACKGROUND

The following description is provided to assist the understanding of the reader. None of the information provided or references cited are admitted to be prior art.

Various types of connectors are used for forming electrical connections between two electrical components. For example, some electrical connectors utilize a plug-socket arrangement where a plug is provided on a first electrical component (e.g., a printed circuit board) and a socket is provided on the second electrical component (e.g., a printed circuit board). To connect the first electrical component to the second electrical component, the plug is inserted into the socket. However, such electrical connectors are costly in terms of the space on the printed circuit boards that they occupy. Thus in some applications, other types of electrical connectors (e.g., single way connectors) may be used. However, such other types of electrical connectors may be difficult to install and be limited in their ability to establish a reliable electrical connection. Thus, existing electrical connectors that connect two electrical components are limited in how they are configured and how they operate.

### SUMMARY

The devices and methods of this disclosure each have several innovative aspects, no single one of which is solely responsible for the desirable attributes disclosed herein.

In accordance with some embodiments of the present disclosure, an electrical contact is disclosed. The electrical contact includes a base having a first edge and a second edge opposite the first edge. The base is configured to electrically connect with a first electrical component. The electrical contact also includes a first section extending from the first edge and a second section extending from the second edge, and including a contact portion to electrically connect with a second electrical component. The second section further includes a pre-load shelf configured to engage with the first section to electrically connect the first electrical component to the second electrical component.

In accordance with some embodiments of the present disclosure, an electrical contact is disclosed. The electrical contact includes a base having a first edge and a second edge opposite the first edge. The base is configured to electrically connect with a first electrical component. The electrical contact also includes a first bend portion extending from the first edge and a first linear portion extending from the first bend portion. The first linear portion includes an opening. The electrical contact also includes a second bend portion extending from the second edge, a second linear portion extending from the second bend portion, a contact portion connected to the second linear portion and configured to electrically connect with a second electrical component, and a pre-load shelf connected to the contact portion and configured to engage with the opening of the first linear portion to electrically connect the first electrical component to the second electrical component.

In accordance with some embodiments of the present disclosure, a method is disclosed. The method includes engaging a second section of an electrical contact at a first contact point of an opening defined in a first section of the electrical contact. The first section extends from a first edge of a base of the electrical contact and the second section extends from a second edge of the base. The method also includes connecting the base with a first electrical component and deflecting the second section to a second contact point of the opening upon compressing a second electrical component on a contact portion of the second section for electrically connecting the first electrical component with the second electrical component.

### BRIEF DESCRIPTION OF THE DRAWINGS

FIG. 1 depicts an example electrical contact in a pre-loaded state, in accordance with an illustrative embodiment.

FIG. 2 depicts an example of the electrical contact of FIG. 1 in a free state, in accordance with an illustrative embodiment.

FIG. 3 depicts an example of the electrical contact of FIG. 1 electrically connected to a first electrical component (e.g., a first Printed Circuit Board (“PCB”)), in accordance with an illustrative embodiment.

FIG. 4 depicts an example of the electrical contact of FIG. 1 electrically connected the first electrical component and to a second electrical component (e.g., a second PCB), in accordance with an illustrative embodiment.

FIG. 5 depicts an example of a stamping of a single electrical contact in a free state, in accordance with an illustrative embodiment.

FIG. 6 depicts a stamping progression of the electrical contact of FIG. 1 from a flat state through the free state of FIG. 2 to the pre-loaded state of FIG. 1, in accordance with an illustrative embodiment.

FIG. 7 depicts a top view of a pocket tape with singulated electrical contacts loaded into individual pockets for delivery, in accordance with an illustrative embodiment.

FIG. 8 depicts an example flowchart outlining operations for manufacturing the electrical contact of FIG. 1, in accordance with an illustrative embodiment.

FIG. 9 depicts an example flowchart outlining operations for using the electrical contact of FIG. 1 for electrically connecting the first electrical component to the second electrical component, in accordance with an illustrative embodiment.

### DETAILED DESCRIPTION

Reference will now be made to various embodiments, one or more examples of which are illustrated in the figures. The embodiments are provided by way of explanation of the invention and are not meant as a limitation of the invention. For example, features illustrated or described as part of one embodiment may be used with another embodiment to yield still a further embodiment. It is intended that the present application encompass these and other modifications and variations as come within the scope and spirit of the invention.

Disclosed herein is an electrical contact or connector. The electrical contact may be used with a variety of electrical components. For example, the electrical contact may be interposed between printed circuit boards (“PCBs”), ground planes, contactors, bus bars, or any other conductive surface. In some embodiments, the electrical contact is connected to one surface, such as a first PCB, and rely on a spring force (e.g., pre-set force) to maintain an electrical connection with a second surface, such as a second PCB. In some embodiments, the electrical contact is formed from a single piece of stamped metal. Thus, the electrical contact provides a high current carrying capability to efficiently and reliably electrically couple the first PCB to the second PCB (or other electrically conductive contact surface) via a single one-piece connector. Thus, the electrical contact allows for efficient and rapid creation of an electrical connection between two electrical components. Furthermore, the unique design of the electrical contact allows for the electrical contact to be constructed out of a single piece of conductive material. This construction minimizes the number of components that must be manufactured and connected to one another to form the contact, and thus simplifies the manufacturing process.

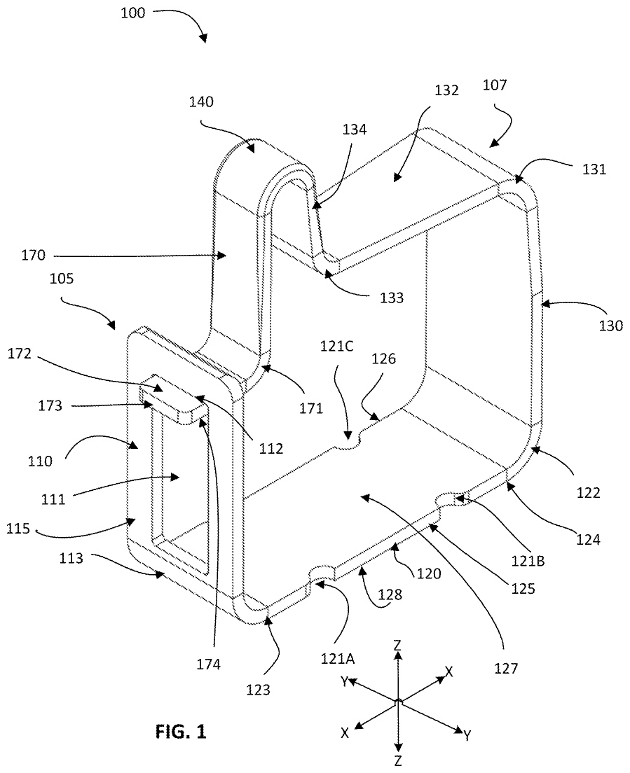

FIG. 1 depicts an electrical contact 100 in a pre-loaded state in accordance with an illustrative embodiment. The electrical contact 100 may be stamped from a single metal sheet. Alternate embodiments may not stamp the electrical contact 100 from the single metal sheet, such as embodiments which stamp the electrical contact 100 from a plurality of metal sheets. Some embodiments may use a plurality of materials in the electrical contact 100. The electrical contact 100 manufactured from the plurality of materials may include welding joints, compression fittings, rivets, bends, screws, or other connections. Moreover, some embodiments may not include sheets of material, as in the case of an electrical contact 100 made by 3-D printing, or other forms of additive manufacturing, or in the case of a molded electrical contact (e.g., the electrical contact 100).

In some embodiments, the electrical contact 100 may be made from steel, silver, high strength silver alloy, copper, high strength copper alloy, etc. In other embodiments, the electrical contact 100 may be made from other conductive materials, including suitable conductive materials selected for different applications according to their various requirements (such as ductility, cost, strength, fatigue properties, application temperature, etc.). In other embodiments, the electrical contact 100 may be made from non-conductive and/or non-metal materials, and may rely on conductive coatings for electrical connections. For example, the electrical contact 100 may include a high strength polymer covered in a metalized film or other coating. In some embodiments, conductive coatings may be applied even if the electrical contact 100 is composed of a conductive material. The coating(s) may be applied through any process (e.g. dipping, electroplating, spraying, etc.), and may be used on metal or non-metal surface to improve the properties of the electrical contact (with respect to conductivity, corrosion resistance, etc.). In some embodiments, such coatings may vary according to use and interfacing materials (e.g. a coating which is used in combination with an electrical contact 100 made from steel may not be suitable for an electrical contact 100 made from silver or polymer, and a coating intended to couple to a copper surface may be undesirable for use with an aluminum surface, etc.). Some embodiments may include coatings of multiple materials, such as gold over nickel. Generally speaking, the electrical contact 100 may be made in a variety of ways to facilitate electrical connection between two electrical components. In some embodiments, the electrical contact 100 or portions thereof may be disposed within a housing.

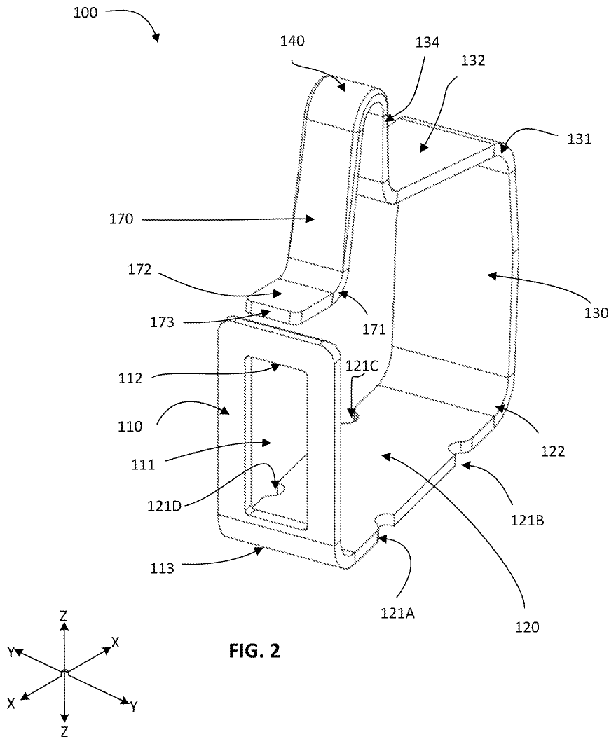

The electrical contact 100 includes a base 120 having a first base edge 123, a second base edge 124, a third base edge 125, and a fourth base edge 126. The base 120 may also include a top surface 127 and a bottom surface 128. In some embodiments, the base 120 may include one or more cutouts disposed along the third base edge 125 and/or the fourth base edge 126. For example, in some embodiments, the base 120 may include a first cutout 121A and a second cutout 121B disposed along the third base edge 125, and a third cutout 121C and a fourth cutout 121D (see FIG. 2) disposed along the fourth base edge 126. The first cutout 121A, the second cutout 121B, the third cutout 121C, and the fourth cutout 121D may aid in the manufacturing of the electrical contact 100 (e.g., connecting to a stamping carrier). In some embodiments, one or more of the first cutout 121A, the second cutout 121B, the third cutout 121C, and the fourth cutout 121D may extend from the top surface 127 to the bottom surface 128 of the base 120. Although the first cutout 121A, the second cutout 121B, the third cutout 121C, and the fourth cutout 121D have been shown as having a particular configuration, in other embodiments, one or more of those cutouts may vary in shape, size, and placement. Although four cutouts are shown in FIG. 1, the number of cutouts and their relative placement may vary in other embodiments. Additionally, the number of cutouts on each of the third base edge 125 and the fourth base edge 126 may vary. Some embodiments may eschew the use of any cutout on the base 120. The shape and size of the base 120 may also vary in other embodiments. For example, although the base 120 is shown to be generally rectangular in shape, in other embodiments, the base may assume other shapes and sizes.

The base 120 includes a first section 105 extending from the first base edge 123 and a second section 107 extending from the second base edge 124. The first section 105 includes a first bend portion 113 extending from the first base edge 123 and connecting the base 120 to a first linear portion 110. The second section 107 includes a second bend portion 122 extending from the second base edge 124 and connecting the base 120 to a second linear portion 130. The second section 107 also includes a third linear portion 132 extending from a third bend portion 131 that extends from the second linear portion 130. Additionally, the second section 107 includes a fourth linear portion 134 extending from a fourth bend portion 133, which in turn extends from the third linear portion 132. The second section 107 further includes a contact portion 140 extending from the fourth linear portion 134 and connecting to a fifth linear portion 170 of the second section. The fifth linear portion 170 extends between the contact portion 140 and a fifth bend portion 171 to mate with a sixth linear portion 172 of the second section 107. The sixth linear portion 172 is also referred to herein as a pre-load shelf and is configured to engage with the first linear portion 110 of the first section 105.

In some embodiments, the first linear portion 110 and the second linear portion 130 extend parallel or substantially parallel to one another in the same direction (e.g., Z-direction) away from the base 120. In some embodiments, a height (e.g., length in the Z-direction) of the first linear portion 110 as measured from the top surface 127 of the base 120 may be less than the height of the second linear portion 130 as measured from the top surface of the base. In some embodiments, the fourth linear portion 134 and the fifth linear portion 170 may also extend parallel or substantially parallel to the first linear portion 110 and the second linear portion 130 in the Z direction. In some embodiments, the height of the fifth linear portion 170 in the Z direction may be greater than the height of the fourth linear portion 134 in the Z direction. In some embodiments, the contact portion 140 may be U-shaped or substantially U-shaped. Further, in some embodiments, the third linear portion 132 and the sixth linear portion 172 may extend parallel or substantially parallel to the base 120 in the X-direction. In some embodiments, the distance between the third linear portion 132 and the base 120 may be greater than the distance between the sixth linear portion 172 and the base. Likewise, in some embodiments, the distance between the third linear portion 132 and the base 120 may be less than the distance between the contact portion 140 and the base.

The relative size and shape of one or more of the first linear portion 110, the second linear portion 130, the third linear portion 132, the fourth linear portion 134, the fifth linear portion 170, and the sixth linear portion 172 may vary from one embodiment to another. For example, in some embodiments, the second linear portion 130 may be wider in the Y-direction compared to each of the first linear portion 110, the third linear portion 132, the fourth linear portion 134, the fifth linear portion 170, and the sixth linear portion 172. In some embodiments, the wider width of the second linear portion 130 may make the electrical contact 100 more robust and mechanically strong. In some embodiments, the width of the second linear portion 130 may be same as or substantially similar to the width of the base 120 in the Y-direction. In other embodiments, the width of the second linear portion 130 may be same as or substantially similar to the width of the first linear portion 110, the third linear portion 132, the fourth linear portion 134, the fifth linear portion 170, and/or the sixth linear portion 172 in the Y-direction. Similarly, in some embodiments, the width of the third linear portion 132 in the Y-direction may be less than the width of the base 120. In some embodiments, the width of the sixth linear portion 172 in the Y-direction may be less than the width of the third linear portion 132. In other embodiments, the relative widths of one or more of the first linear portion 110, the second linear portion 130, the third linear portion 132, the fourth linear portion 134, the fifth linear portion 170, and/or the sixth linear portion 172 may vary from that shown.

Additionally, in some embodiments, the thickness of one or more of the first linear portion 110, the second linear portion 130, the third linear portion 132, the fourth linear portion 134, the fifth linear portion 170, and the sixth linear portion 172 may be the same. In other embodiments, the thicknesses of one or more of the first linear portion 110, the second linear portion 130, the third linear portion 132, the fourth linear portion 134, the fifth linear portion 170, and the sixth linear portion 172 may vary from one another. Generally speaking, although the first linear portion 110, the second linear portion 130, the third linear portion 132, the fourth linear portion 134, the fifth linear portion 170, and the sixth linear portion 172 have been shown and described as having a certain configuration, in other embodiments, the configuration (e.g., the size, shape, etc.) of one or more of those linear portions may vary in other embodiments. Further, in some embodiments, the number of the linear portions (e.g., the first linear portion 110, the second linear portion 130, the third linear portion 132, the fourth linear portion 134, the fifth linear portion 170, and the sixth linear portion 172) in the electrical contact 100 may vary in other embodiments. Specifically, in other embodiments, the electrical contact 100 may include fewer than or greater than six linear portions.

Each of the first bend portion 113, the second bend portion 122, the third bend portion 131, the fourth bend portion 133, and the fifth bend portion 171 may be configured with a particular curvature to facilitate connection of two linear portions of the electrical contact 100 while allowing some degree of flexibility to flex or move those linear portions. For example, in some embodiments, the first bend portion 113 that connects the first linear portion 110 to the base 120 allows the first linear portion some degree of flexibility to enable the electrical contact 100 to connect two electrical components (e.g., first PCB and a second PCB) and to move from the pre-loaded state to a free state, and from the free state to a pre-loaded state. Similarly, in some embodiments, the second bend portion 122 that connects the base 120 to the second linear portion 130 allows some degree of flexibility to the base and the second linear portion, the third bend portion 131 that connects the second linear portion to the third linear portion 132 allows some degree of flexibility in the second linear portion and the third linear portion, and so on. Alternate embodiments of the electrical contact 100 may contain fewer or additional bend portions than that shown. For example, in some embodiments, the second linear portion 130 may extend directly from the second bend portion 122 to the contact portion 140 without any intervening bends or additional linear portions.

The degree of curvature of each of the first bend portion 113, the second bend portion 122, the third bend portion 131, the fourth bend portion 133, and the fifth bend portion 171 may vary from one embodiment to another depending upon the degree of flexibility desired and the relative positioning of two linear portions that a particular bend portion connects. For example, some bend portions (e.g., one or more of the first bend portion 113, the second bend portion 122, the third bend portion 131, the fourth bend portion 133, and the fifth bend portion 171) may be of constant radius, while other bend portions may be of varied radius, or even zero radius (e.g. extremely sharp bends, such as two portions connected at 90 degrees or other angles). Changing the geometry of the various bend portions and/or the configuration of the various portions may impact the strength of the electrical contact 100, the amount of spring force exerted by the electrical contact, the stress imposed on any contemplated solder pad affixed to the bottom surface 128 of the base 120, the stress imposed on the various linear portions (e.g., the first linear portion 110, the second linear portion 130, the third linear portion 132, the fourth linear portion 134, the fifth linear portion 170, and the sixth linear portion 172), and/or other properties of the electrical contact 100. Such variations in geometry may include changes in the radius and angle of one or more of the first bend portion 113, the second bend portion 122, the third bend portion 131, the fourth bend portion 133, and the fifth bend portion 171, the number of bend portions, the number of portions (e.g., the first linear portion 110, the second linear portion 130, the third linear portion 132, the fourth linear portion 134, the fifth linear portion 170, and the sixth linear portion 172), etc.

Although the various linear portions (e.g., the first linear portion 110, the second linear portion 130, the third linear portion 132, the fourth linear portion 134, the fifth linear portion 170, and the sixth linear portion 172) and the bend portions (e.g., the first bend portion 113, the second bend portion 122, the third bend portion 131, the fourth bend portion 133, and the fifth bend portion 171) have been described as distinct elements, in some embodiments, each of those portions and bend portions are integrated such that the electrical contact 100 is formed as a single integrated piece. The various linear portions and bend portions may simply be indicative of how a metal sheet (or other material) is bended, folded or otherwise deformed or molded to form the structure of the electrical contact as a single integrated piece. In other embodiments, one or more bend portions (e.g., the first bend portion 113, the second bend portion 122, the third bend portion 131, the fourth bend portion 133, and the fifth bend portion 171) and/or one or more linear portions (e.g., the first linear portion 110, the second linear portion 130, the third linear portion 132, the fourth linear portion 134, the fifth linear portion 170, and the sixth linear portion 172) may be connected in operational association by other means such as soldering, welding, riveting, gluing, or other fastening mechanisms.

Referring still to FIG. 1, the first linear portion 110 defines an opening 111 having an edge 112 that is configured to receive and engage a terminus or pre-load lip 173 of the sixth linear portion 172. In some embodiments, the width of the pre-load lip 173 may be same as or substantially similar to the width of the opening 111 to facilitate engagement of the pre-load lip with the edge 112 to achieve the pre-load or pre-loaded state (the terms “pre-load” and “pre-loaded”are used interchangeably herein). In other embodiments, the pre-load lip 173 may engage with the opening 111 in other ways. Further, in some embodiments, the electrical contact 100 may include additional openings on the first linear portion 110 defining additional edges (e.g., similar to the edge 112), which may allow additional pre-load settings. For example, in some embodiments, the opening 111 may be bisected to form two separate openings such that the pre-load lip 173 may engage with either of the two openings. In other embodiments, the opening 111 may be divided into more than two openings depending upon the amount of deflection of the pre-load lip 173 that is desired as well as the number of pre-load locations that are desired.

The electrical contact 100 also includes the contact portion 140. The contact portion 140 is configured to electrically connect with an electrical component (e.g., PCB). Specifically, in some embodiments, a first electrical component (e.g., first PCB) may be connected to the base 120 and a second electrical component (e.g., second PCB) may be connected to the contact portion 140 by compression. Since the electrical contact 100 is constructed from a conductive material, the contact portion 140 and the base 120 facilitate establishment of an electrical connection between the first electrical component (e.g., the first PCB) and the second electrical component (e.g., the second PCB) via the first linear portion 110, the second linear portion 130, the third linear portion 132, the fourth linear portion 134, the fifth linear portion 170, and the sixth linear portion 172, as well as the various bend portions connecting those linear portions.

In some embodiments, the contact portion 140 may be defined by a bend between the fourth linear portion 134 and the fifth linear portion 170. In one embodiment, the bend of the contact portion 140 may be a U-shaped or hemispherical bend of constant radius. Such a design may concentrate contact force on an edge of the contact portion 140 facing opposite the base 120, and allow an electrical connection to be maintained in the event of slight misalignment. In other embodiments, the contact portion 140 may include additional bends, or have no bends, such as a flat surface.

To assemble the electrical contact 100 in the pre-loaded state, the fifth linear portion 170 of the electrical contact may be pushed (e.g., pressed or compressed) towards the top surface 127 of the base 120 and towards the opening 111 of the first linear portion 110 until the pre-load lip 173 engages (e.g., contacts, abuts, proximate) with the edge 112 of the first linear portion. In some embodiments, upon contacting the edge 112, the pre-load lip 173 may continue to be pushed into the opening 111 such that a portion 174 of the pre-load lip protrudes out of the opening to the other side of the opening, as shown in FIG. 1. Because the spring force of the electrical contact 100 exerts a force on the fifth linear portion 170, the pre-load lip 173 may make contact with the edge 112, and retain the pre-load lip in the pre-load position, as shown in FIG. 1. In other embodiments, the pre-load lip 173 may be engaged with the edge 112 of the opening 111 such that the pre-load lip is flush with a first face 115 of the first linear portion 110 or a gap exists between the first face and an edge of the pre-load lip. In other embodiments, the engagement of the pre-load lip 173 with the opening 111 may be at a point other than the edge 112. Generally speaking, the pre-load lip 173 may engage with the opening 111 at a first point of engagement in the pre-load state. The first point of engagement may be the edge 112 or another location within the opening 111. The design (e.g., the configuration of the various linear portions, bend portions, and contact portion) of the electrical contact 100 provides a first pre-set force to maintain the pre-load lip 173 in engagement with the opening 111 in the pre-load state at the first point of engagement.

Further, in some embodiments, the height of the edge 112 relative to the base 120 may vary to set different pre-load values. For example, in some embodiments, the edge 112 may be closer to the base 120 than in other embodiments. When the edge 112 is closer to the base 120, a first amount of pre-set force may be needed to maintain the pre-load lip 173 in engagement with the opening 111 in the pre-loaded state. Similarly, when the edge 112 is farther away from the base 120, a second amount of pre-set force may be needed to maintain the pre-load lip 173 in engagement with the opening 111 in the pre-loaded state. In some embodiments, the second amount of pre-set force may be greater than the first amount of pre-set force. Thus, by varying the height of the edge 112, the location of engagement of the pre-load lip 173 with the opening 111 may be made to vary, thereby changing the amount of pre-set force, with each pre-set force amount corresponding to one or more pre-load values or pre-load settings. As indicated above, the electrical contact 100 may be held in a pre-loaded state or a free state. The pre-loaded state is shown in FIG. 1 in which the pre-load lip 173 engages with the opening 111. The free state is shown in FIG. 2 in which the pre-load lip 173 is not engaged with the opening 111.

Thus, referring now to FIG. 2 in conjunction with FIG. 1, the electrical contact 100 is shown in a free state, in accordance with some embodiments of the present disclosure. In the free state, the pre-load lip 173 is not engaged with the opening 111. In some embodiments, in the free state, the sixth linear portion 172 is displaced away and spaced apart from the first linear portion 110. In some embodiments, the free state may be obtained by flexing or pushing the pre-load lip 173 out of engagement with the edge 112 of the opening 111. Due to spring force and resiliency in the various linear portions and bend portions of the electrical contact 100, when the pre-load lip 173 is free from the opening 111, the third linear portion 132, the fourth linear portion 134, the fifth linear portion 170, and the sixth linear portion 172 deflect away from the first linear portion 110 (and possibly away from the base 120 as well). From the free state, the electrical contact 100 may be moved to the pre-load state of FIG. 1, as described above, by flexing the sixth linear portion 172 towards the first linear portion 110 and engaging the pre-load lip 173 with the edge 112 of the opening 111. Thus, the electrical contact 100 may be moveable between the free state of FIG. 2 and the pre-load state of FIG. 1.

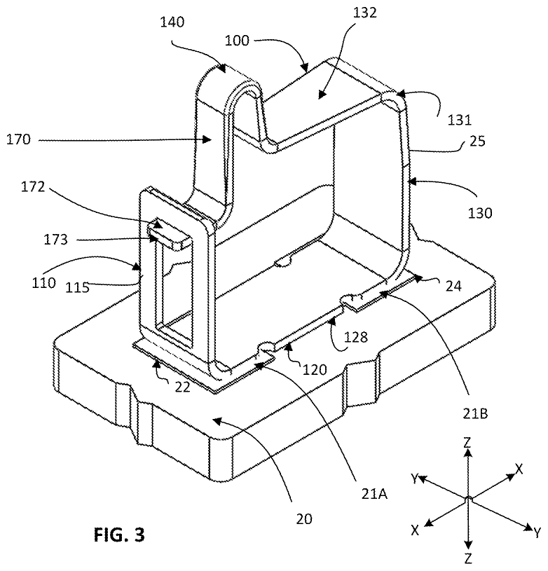

Turning now to FIG. 3, the electrical contact 100 mounted to a first electrical component is shown, in accordance with an embodiment of the present disclosure. In some embodiments, the first electrical component may be a first printed circuit board (PCB) 20. Thus, FIG. 3 shows the electrical contact 100 electrically connected to the first PCB 20. In other embodiments, the first electrical component may be another type of electrical component that is desired to be connected to another electrical component via the electrical contact 100. In some embodiments, the electrical contact 100 may be mounted to the first PCB 20 by a first electrical connection element 21A and a second electrical connection element 21B. In some embodiments, the first electrical connection element 21A and the second electrical connection element 21B may be disposed on a surface (e.g., top surface or surface that comes in contact with the electrical contact 100) of the first PCB 20 for connection to the electrical contact. In other embodiments, the first electrical connection element 21A and the second electrical connection element 21B may be disposed on the bottom surface 128 of the base 120. Further, in some embodiments, an instance of the first electrical connection element 21A and the second electrical connection element 21B may be provided on the bottom surface 128 of the base 120, as well as on the top surface of the first PCB 20.

In some embodiments, either or both of the first electrical connection element 21A and the second electrical connection element 21B may include a solder pad to form a solder joint that mechanically and electrically connects the electrical contact 100 to the first PCB 20. For example, in some embodiments, the first electrical connection element 21A and the second electrical connection element 21B configured as a solder pad may be attached to a top surface of the first PCB 20. The bottom surface 128 of the base 120 may then be connected to the solder pad to form a solder joint, thereby connecting the first PCB to the electrical contact. In other embodiments, the first electrical connection element 21A and the second electrical connection element 21B configured as a solder pad may be connected to the bottom surface 128 of the base 120, and the first PCB 20 may be joined to the solder pad to form a solder joint. In other embodiments, either or both of the first electrical connection element 21A and the second electrical connection element 21B may be another type of conductive connection that is suitable for facilitating an electrical connection between the electrical contact 100 and the first PCB 20 (e.g., pogo pins, compression, pastes, PCB through hole contact, PCB surface plating, etc.). Further, in some embodiments, a single electrical connection element (e.g., either the first electrical connection element 21A or the second electrical connection element 21B) may be used to electrically connect the electrical contact 100 to the first PCB 20. In other embodiments, greater than two electrical connection elements may be used.

Additionally, the positioning or placement of the first electrical connection element 21A and the second electrical connection element 21B with respect to the base 120 of the electrical contact 100 and the first PCB 20 may vary from one embodiment to another. In some embodiments, the first electrical connection element 21A and the second electrical connection element 21B may be spaced apart from one another, as shown in FIG. 3. For example and as shown in FIG. 3, in some embodiments, the first electrical connection element 21A may be positioned to align with one end of the base 120 (e.g., adjacent the first linear portion 110) and the second electrical connection element 21B may be formed to align with the other end of the base (e.g., adjacent the second linear portion 130). In other embodiments, the first electrical connection element 21A and the second electrical connection element 21B may be in contact with each other. For example, in some embodiments, the first electrical connection element 21A and the second electrical connection element 21B may be formed as a single continuous piece extending from one end of the base 120 to the other end of the base. In other embodiments, the first electrical connection element 21A and the second electrical connection element 21B may be formed towards a center portion of the base 120.

Moreover, the size of each of the first electrical connection element 21A and the second electrical connection element 21B may vary from one embodiment to another. For example, in some embodiments, each of the first electrical connection element 21A and the second electrical connection element 21B may be formed to have a width in the Y direction that is wider than the width of the base 120 in the Y direction such that the first electrical connection and the second electrical connection extend beyond the bottom surface 128 of the base, thereby ensuring a maximum surface area of contact between the electrical contact 100 and the first PCB 20. In other embodiments, the width of the first electrical connection element 21A and the second electrical connection element 21B may be less than or equal to the width of the base 120 in the Y direction. Further, in some embodiments, the first electrical connection element 21A may be positioned such that an edge 22 of the first electrical connection extends beyond the face 115 of the first linear portion 110 in the X direction. Similarly, in some embodiments, the second electrical connection element 21B may be positioned such that an edge 24 of the second electrical connection extends beyond a face 25 of the second linear portion 130. In other embodiments, the positioning/placement of the first electrical connection element 21A and/or the second electrical connection element 21B may vary from that shown.

Further, the shape of each of the first electrical connection element 21A and the second electrical connection element 21B may vary from one embodiment to another. For example, although each of the first electrical connection element 21A and the second electrical connection element 21B are shown as being square or substantially square in shape, in other embodiments, the first electrical connection and/or the second electrical connection may assume other shapes.

Likewise, although the first electrical connection element 21A and the second electrical connection element 21B are shown as being same or similar in size, in other embodiments, the relative sizes of the two electrical connection elements may vary. Generally speaking, the shape, size, and other configuration of the first electrical connection element 21A and the second electrical connection element 21B may vary from one embodiment to another to provide the desired electrical connection between the electrical contact 100 and the first PCB 20.

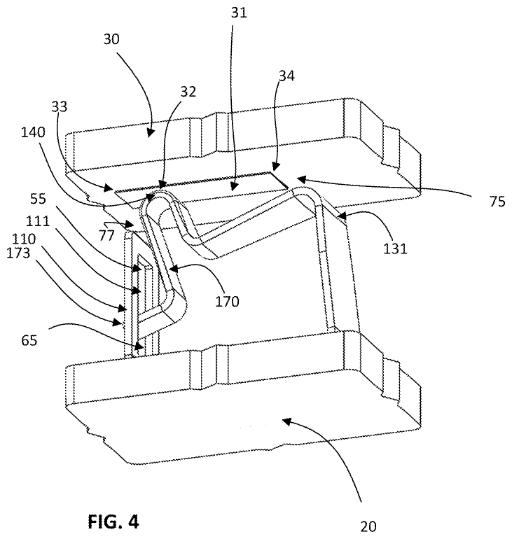

Turning now to FIG. 4, the electrical contact 100 disposed between the first PCB 20 and a second electrical component is shown, in accordance with some embodiments of the present disclosure. In some embodiments, the second electrical component may be a second PCB 30. Thus, the electrical contact 100 may be used to electrically connect the first PCB 20 to the second PCB 30. In other embodiments, the second electrical component may be another type of electrical component that is desired to be connected to the first PCB 20 via the electrical contact 100.

To electrically connect the first PCB 20 with the second PCB 30, the electrical contact 100 is situated between the first PCB, as discussed above in FIG. 3, and the second PCB. Similar to the first PCB 20, the second PCB 30 may include an electrical connection element 31 that facilitates an electrical (and possibly mechanical) connection between the electrical contact 100 and the second PCB 30. In some embodiments, the electrical connection element 31 may be disposed on a bottom surface (e.g., the surface that contacts the electrical contact 100) of the second PCB 30.

In some embodiments, the electrical connection element 31 may be a plated area on a surface of the second PCB 30. In some embodiments, the plated area may be of a material similar to the material of which the electrical contact 100 is formed. In other embodiments, the electrical connection element 31 may be another type of conductive connection element that is suitable for facilitating an electrical connection between the electrical contact 100 and the second PCB 30 (e.g., pogo pins, compression, pastes, PCB through-hole contact, PCB surface plating, etc.). In some embodiments, the second PCB 30 may not be mechanically connected to the electrical contact 100. Rather, only an electrical connection may exist between the second PCB 30 and the electrical contact 100. For example, in some embodiments, an electrical connection between the second PCB 30 and the electrical contact 100 may be achieved by the deflection of the pre-load lip 173 into the opening 111, as discussed below. In other embodiments, the electrical connection element 31 may include a solder pad. For example, in some embodiments, the electrical connection element 31 configured as a solder pad may be attached to the second PCB 30. The top surface of the contact portion 140 may then be connected to the solder pad to form a solder joint, thereby mechanically and electrically connecting the second PCB to the electrical contact. Further, although a single instance of the electrical connection element 31 has been shown in FIG. 4, in some embodiments, multiple instances of the electrical connection element 31 may be used to electrically connect the electrical contact 100 to the second PCB 30.

In some embodiments, the electrical connection element 31 may be positioned on the second PCB 30 such that upon electrically connecting the second PCB to the electrical contact 100, the second PCB is parallel or substantially parallel to the first PCB 20, and/or vertically aligned with the first PCB. Thus, in some embodiments, when the electrical connection element 31 is provided on the surface of the second PCB 30, the electrical connection element may need to be somewhat offset from a center of the surface on which the electrical connection element is provided to enable the parallel (or substantially parallel) and/or vertical alignment with the first PCB 20, while facilitating an electrical connection with the contact portion 140. In other embodiments, the electrical connection element 31 may be mounted to achieve other desired relative alignments and/or angles with the first PCB 20. Further, the size and shape of the electrical connection element 31 may vary from one embodiment to another. Although the electrical connection element 31 has been shown as being rectangular (or substantially rectangular) in shape in FIG. 4, in some embodiments, the electrical connection element may assume other shapes. In some embodiments, the electrical connection element 31 may be sized larger than the area actually needed for the electrical connection between the electrical contact 100 and the second PCB 30. By providing a larger size of the electrical connection element 31, the electrical contact point between the electrical contact 100 and the second PCB 30 may be varied to achieve a desired alignment and angle of the second PCB relative to the first PCB 20, as well as to achieve a desired loaded state.

In some embodiments and as shown in FIG. 4, upon connection, the second PCB 30 may have a single electrical contact point (e.g., contact point 32) between the electrical connection element 31 and the contact portion 140 of the electrical contact 100. The location of the contact point 32 on the electrical connection element 31 may depend upon the amount of deflection of the pre-load lip 173 into the opening 111. For example, when the pre-load lip 173 is pushed farther away from the second PCB 30 and farther away from the edge 112 into the opening 111 and towards the base 120, the contact point 32 may be closer to an edge 33 of the electrical connection element 31. On the other hand, if the pre-load lip 173 is closer to the edge 112 in the opening 111 and closer to the second PCB 30, the contact point 32 may be closer to an edge 34 of the electrical connection element 31. Thus, depending upon the location of the pre-load lip 173 in the opening 111 when the second PCB 30 is connected to the electrical contact 100, the location of the contact point 32 may vary. In some embodiments, the electrical connection element 31 may be sized to be large enough such that the contact point 32 may be achieved for every (or at least some designated) locations of the pre-load lip 173 in the opening 111.

Although FIG. 4 shows a single contact point (e.g., the contact point 32), in some embodiments, additional contact points between the second PCB 30 and the electrical contact 100 may be achieved. For example, in some embodiments, an additional electrical connection may be achieved between the electrical connection element 31 and the third bend portion 131. In some embodiments, the size of the electrical connection element 31 may be varied to provide for multiple contact points. In other embodiments, additional or other contact points between the electrical connection element 31 and the electrical contact 100 may be provided. In some embodiments, such multiple contact points may increase the effectiveness of the electrical connection between the first PCB 20 and the second PCB 30, as well as provide mechanical support to the second PCB and maintain the desired alignment/angle between the second PCB and the first PCB.

In some embodiments, the electrical connection between the second PCB 30 and the electrical contact 100 may be achieved by a deflection/flexing of the pre-load lip 173 into the opening 111 to a second point of engagement from the first point of engagement. This deflected state of the pre-load lip 173 resulting in the electrical connection of the second PCB 30 to the electrical contact 100 may be considered a loaded state of the electrical contact. In this loaded state, the pre-load lip 173 may be deflected towards the first PCB 20 in the opening 111. The deflection may result in an additional spring force, which, in combination with the pre-load spring force (e.g., the first amount of pre-set force), may provide the force of the connection between the contact portion 140 and the second PCB 30. Thus, the design (e.g., the configuration of the various linear portions, bend portions, and the contact portion) of the electrical contact 100 provides a second amount of pre-set force to maintain engagement of the pre-load lip 173 in the deflected state (e.g., the loaded state) within the opening 111 at the second point of engagement.

The amount of deflection to the second point of engagement may vary based upon the size of the electrical connection element 31 to achieve the contact point 32 with the contact portion 140 and the alignment/angle desired between the second PCB 30 and the first PCB 20. In some embodiments, the deflection of the pre-load lip 173 in the opening 111 may be achieved by simply positioning the second PCB 30 over the electrical contact 100 and applying downward force (e.g., compressing) such that the electrical connection element 31 contacts the contact portion 140. In other embodiments, the pre-load lip 173 may first be deflected into the opening 111 before the second PCB is positioned over the contact portion 140.

In the loaded state, in some embodiments, a first gap 55 may be present between the pre-load lip 173 and the edge 112, a second gap 65 may be present between the pre-load lip and the edge of the opening 111 closest to the base 120, a third gap 75 may be present between the third bend portion 131 and the electrical connection element 31, and a fourth gap 77 may be present between the first linear portion 110 and the fifth linear portion 170. In some embodiments, these gaps may increase the design margin of the distance between the first PCB 20 and the second PCB 30 (due to PCB flex, mounting hardware, or any other reason). In some embodiments, one or more of the first gap 55, the second gap 65, the third gap 75, and the fourth gap 77 need not be present.

In the loaded state, an electrical connection may exist between the first PCB 20 and the second PCB 30 via the electrical contact 100. Thus, the electrical contact 100 may be configured to electrically connect the first PCB 20 to the second PCB 30 by moving the electrical contact from a pre-load state in which the pre-load lip is engaged with an edge 112 of the opening 111 (or having a first point of engagement in the opening) to a loaded state in which the pre-load lip is deflected within the opening (or having a second point of engagement in the opening that is different from the first point of engagement).

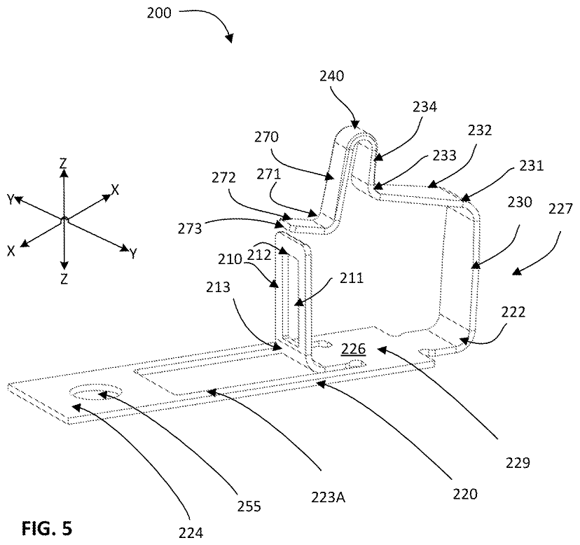

Turning to FIG. 5, an example of an electrical contact 200 is shown, in accordance with some embodiments of the present disclosure. The electrical contact 200 may be formed from a stamping 224. In some embodiments, the stamping 224 be a single integrated piece and may include various surfaces and/or cutouts that define the various linear portions and bend portions of the electrical contact 200. In some embodiments, the stamping 224 may be composed of a single sheet of metal. In other embodiments, the stamping 224 may be composed of other desired materials for the electrical contact 200. In other embodiments, the stamping 224 may be composed of multiple materials (e.g., different portions of the stamping may be composed of different materials). The electrical contact 200 may be formed by bending, folding, deforming or otherwise molding (collectively referred to herein as bending) the stamping 224 to form the various linear portions and bend portions of the electrical contact, as discussed above with respect to the electrical contact 100. The shape and size of the stamping 224 may vary to define the desired shape and size of the electrical contact 200.

In some embodiments, the stamping 224 may include a first surface 220 in which a cutout 223A may be provided to define a first linear portion 210 having an opening 211 defining an edge 212 and a first bend portion 213. The first linear portion 210 is analogous to the first linear portion 110, the opening 211 is analogous to the opening 111, and the first bend portion 213 is analogous to the first bend portion 113. The first linear portion 210 may be bent along the first bend portion 213 to obtain the configuration of the first linear portion 110 discussed above. Upon bending the first linear portion 210 and the first bend portion 213, a second surface 229 of the stamping 224 may form a base 226. The base 226 may be analogous to the base 120 of the electrical contact 100. An aperture (e.g., pilot hole) 255 may also be defined on the first surface 220 to aid the manufacture of the electrical contact 200, as well as by providing a clamping point to hold the electrical contact in place to facilitate the bending operations. In some embodiments, the aperture 255 need not be provided. Further, in other embodiments, the stamping 224 may be provided with other or additional features that may be needed or considered desirable to have in aiding the manufacture of the stamping, as well as for facilitating the bending of the stamping to form the electrical contact 200.

The stamping 224 may also include a third surface 227 adjacent to the second surface 229. The third surface 227 may define various bend portions, as well as second through sixth linear portions, the contact portion, and the pre-load lip of the electrical contact 200. For example, the stamping 224 may define a second bend portion 222 that joins a second linear portion 230. By bending the stamping 224 along the second bend portion 222 in the Z direction, the second linear portion 230 may be defined. The second bend portion 222 and the second linear portion 230 are analogous to the second bend portion 122 and the second linear portion 130, respectively. The stamping 224 may also define a third bend portion 231, which joins a third linear portion 232, a fourth linear portion 234, a fourth bend portion 233, a contact portion 240, a fifth linear portion 270, a fifth bend portion 271, a sixth linear portion 272 and a pre-load lip 273. The stamping 224 may be bent along the third bend portion 231, the fourth bend portion 233, the contact portion 240, and the fifth bend portion 271 to achieve the shape of the electrical contact 200 shown in FIG. 5. For example, the stamping 224 may be bent along the third bend portion 231 in the X direction to define the third linear portion 232. The stamping 224 may be bent in the Z direction along the fourth bend portion 233 to define the fourth linear portion 234. Upon defining the fourth linear portion 234, the stamping 224 may be bent in a U-shape or substantially U-shape to define the contact portion 240. The stamping 224 may be bent in the Z direction towards the second surface 229 to define the fifth linear portion 270 and the stamping may be bent in the X direction along the fifth bend portion 271 towards the first linear portion 210 to define the sixth linear portion 272 and the pre-load lip 273. It is to be understood that the various bend portions of the stamping 224 may be bent in any order to define the shape of the electrical contact 200. The third bend portion 231, the third linear portion 232, the fourth linear portion 234, the fourth bend portion 233, the contact portion 240, the fifth linear portion 270, the fifth bend portion 271, the sixth linear portion 272 and the pre-load lip 273 are analogous to the third bend portion 131, the third linear portion 132, the fourth linear portion 134, the fourth bend portion 133, the contact portion 140, the fifth linear portion 170, the fifth bend portion 171, the sixth linear portion 172 and the pre-load lip 173, respectively, of the electrical contact 100.

The electrical contact 200 is shown in a free state in which the pre-load lip 273 is not engaged with the opening 211. In some embodiments, the pre-load lip 273 may be engaged with the opening 211 and particularly with the edge 212 of the opening to obtain a pre-loaded state. In some embodiments, the electrical contact 200 may achieve the pre-loaded state before the remaining portion of the stamping 224 is removed. In other embodiments, the remaining portion of the stamping 224 may be removed before the electrical contact 200 is deflected to achieve the pre-loaded state. In some embodiments, the electrical contact 200 may remain in the free state until the electrical contact is to be used to electrically connect two electrical components. In such embodiments, the electrical contact 200 may be engaged to obtain the pre-loaded state either before the first electrical component (e.g., the first PCB 20) is connected or after the first electrical component is connected but before the second electrical component (e.g., the second PCB 30) is connected. In some embodiments, the remaining portion of the stamping 224 may include that portion of the stamping that does not form part of the first linear portion 210, the first bend portion 213, the base 226, the second linear portion 230, the second bend portion 222, the third bend portion 231, the third linear portion 232, the fourth linear portion 234, the fourth bend portion 233, the contact portion 240, the fifth linear portion 270, the fifth bend portion 271, the sixth linear portion 272 and the pre-load lip 273. The remaining portion of the stamping 224 may be peeled away or otherwise removed from the electrical contact 200.

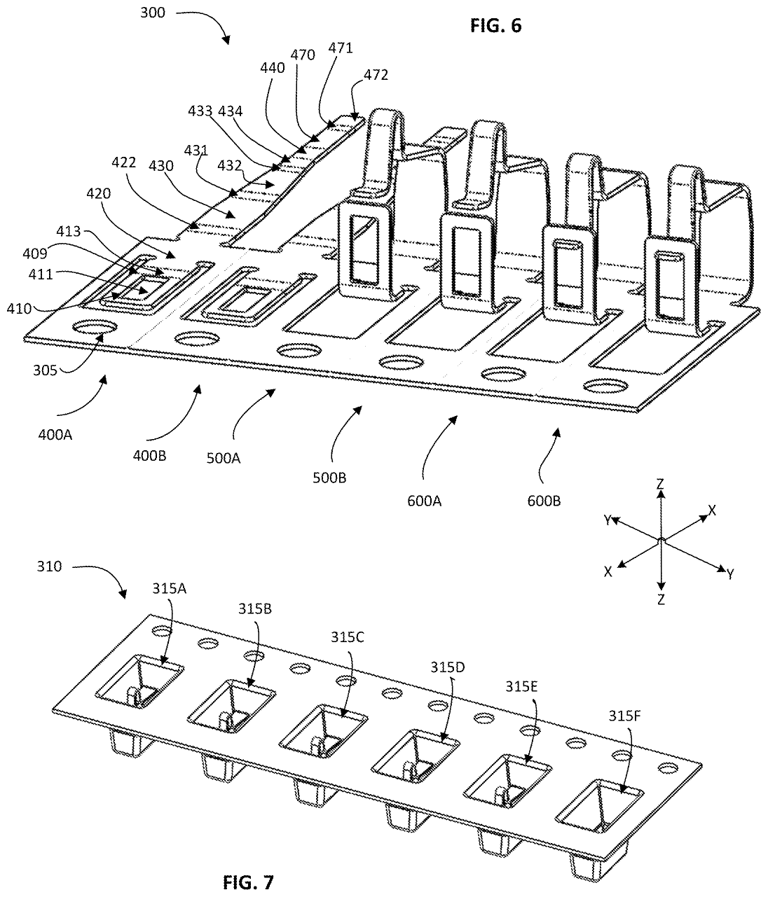

Turning to FIG. 6, a portion of a stamping progression 300 of the electrical contact 100 from a flat state through the free state of FIG. 2 to the pre-loaded state of FIG. 1 is shown, in accordance with some embodiments of the present disclosure. In some embodiments, the electrical contact 100 may be a stamped electrical contact. The stamping progression 300 shows an example stamping process of forming the electrical contact 100. In some embodiments, the electrical contact 100 may be stamped from a continuous strip of thin metal fed through a progressive stamping die. In some embodiments, the progressive stamping die may include multiple stations spaced apart (e.g., equidistant) from one another. This equidistant spacing between two consecutive stations may be referred to as a stamping “pitch.” The metal strip may be advanced through the progressive stamping die one pitch at a time. Each station may be configured to perform one or more operations (e.g., removing material, bending/forming various shapes, etc.) in forming the electrical contact 100. In some embodiments, some stations may be left “empty” (e.g., do not perform any operations) in case changes are required to the stamping process at a later time).

Depending on the operations(s) that each station performs, the number of stations in the progressive stamping die may vary. For example, in some embodiments, one station may be configured to punch a pilot hole 305, which may be used by subsequent stations to ensure precise location for their operations. Thus, the stamping progression 300 includes a thin flat strip of metal that enters one end of the progressive stamping die and exits the other end of the progressive stamping die as a continuous strip of finished electrical contacts (e.g., the electrical contact 100) to be reeled up for use in other processes (e.g., plating and placement into a larger assembly). In some embodiments, a final station of the progressive stamping die may cut (e.g., separate) the individual electrical contacts from the stamping progression 300 for collecting in a box. In other embodiments, the electrical contacts from the stamping progression 300 may be packaged in a pocket tape, as shown in FIG. 7 below.

Thus, the stamping progression 300 shows the electrical contact 100 in various stages of the stamping process (e.g., various stages of material removal and bending). Each stage may be processed at one or more stations of the progressive stamping die. For example, a stamping stages 400A and 400B may be processed through one or more blanking/cutting stations to remove unnecessary material from the metal strip of the stamping progression 300 and defining cut-outs, scoring lines, bend portions, etc. yielding a flat configuration. The blanking/cutting stations may use a variety of techniques such as CNC (Computer Numerical Control) machining, water-jet cutting, laser cutting, etc. may be used to define the various cutouts, scoring lines, guides, bend portions, and other features of the electrical contact 100 to yield the flat configuration. In other embodiments, other or additional mechanisms may be used to define such features.

Referring specifically to the stamping stage 400A, the metal strip of the stamping progression 300 may be processed to achieve the flat configuration, which may include a cutout that defines an opening 411 and a first linear portion 410. The cutout may be created by removing material from the metal strip to define the opening 411 and the first linear portion 410, as well as a region for a first bend portion 413. The flat configuration may also define a region of a second bend portion 422, a region of a third bend portion 431, a region of a fourth bend portion 433, a region of a contact portion 440, and a region of a fifth bend portion 471. Thus, the electrical contact 100 may be bent in subsequent stations of the progressive stamping die to obtain the various linear and bend portions, as discussed above. For example, the metal strip may be bent in the region of the second bend portion 422 to define a second linear portion 430, may be bent in the region of the third bent portion 431 to define a third linear portion 432, may be bent in the region of the fourth bend portion 433 to define a fourth linear portion 434 and the contact portion 440, and may be bent in the region of the fifth bend portion to define a fifth linear portion 470 and a sixth linear portion 472. The various bend portions and linear portions described above are analogous to the various bend portions and portions of the electrical contact 100. Further, the flat configuration of the stamping stage 400A may be formed to include a particular taper from the second linear portion 430 to the sixth linear portion 472 to define the various widths as discussed above. In some embodiments, mechanically stamped guidelines may be used to identify the various bending locations on the metal strip.

Upon defining the cut-outs in the flat configuration, as shown in the stamping stages 400A and 400B, the electrical contact may be bent, as shown in stamping stages 500A, 500B, 600A, and 600B. One or more stations of the progressive stamping die may be used to bend the electrical contact 100. Each of the stamping stages 500A, 500B, 600A, 600B may be representative of one or more stations of the progressive stamping die. In some embodiments, the stamping stages 500A, 500B, 600A, and/or 600B may be performed at the same station. The stamping stages 500A and 500B show the electrical contact 100 bent into a free state, while stamping stages 600A and 600B show the electrical contact bent into a pre-loaded state.

In some embodiments, the progressive stamping die may not be configured to produce the pre-loaded configuration shown in the stamping stages 600A and 600B. Rather, in such embodiments, the pre-loaded configuration of the electrical contact 100 may be achieved by a secondary process (e.g., by a human operator engaging the pre-load lip 173 with the opening 11 to achieve the pre-load state). When the pre-loading is performed by a secondary process, the stamping stages 600A and 600B may not be called “stamping” stages, but rather, simply stages that bend the electrical contact 100 to obtain the pre-loaded state.

Turning now to FIG. 7, a pocket tape 310 is shown, in accordance with some embodiments of the present disclosure. The pocket tape 310, also referred to herein as an embossed carrier tape, may be made from a continuous strip of relatively thin plastic film. This strip of plastic film may be fed through a machine, which heats the plastic film such that smaller sections may be vacuumed and/or blown into precise cavities in the processing line. The cavities may be regularly spaced pockets 315A-315F in the continuous strip of plastic film. Even though the pocket tape 310 is shown as a pocket tape segment having 6 pockets (e.g., the pockets 315A-315F), in other embodiments, the pocket tape 310 may be configured as a continuous strip having any number of pockets therein. Each of the pockets 315A-315F may be specifically designed and produced for the component (e.g., the electrical contact 100) they are intended to carry to provide precise positioning and ability to be picked up by a robot and placed onto a PCB.

The pocket tape 310 shows the electrical contacts (e.g., the electrical contact 100) after they have been cut free from the carrier (e.g., stamping) strip (e.g., along the third base edge 125) and placed into the pockets 315A-315F. One electrical contact may be placed in each of the pockets 315A-315F. Upon placing the electrical contacts (e.g., the electrical contact 100) into the pockets 315A-315F, a thin, transparent cover tape may be bonded to the pocket tape to prevent the electrical contacts from coming out. The pocket tape 310 does not show this cover tape. The filled pocket tape (e.g., the pocket tape 310 covered by the cover tape) may then be wrapped onto a pick-up reel for compact packaging for delivery. The cover tape may be peeled away to allow the electrical contact 100 to be accessed by a robot in the pockets 315A-315F. For example, the surface of the third linear portion 132 may be contacted by a vacuum head of a robot to pick up the electrical contact 100 from a respective one of the pockets 315A-315F. In some embodiments, industry standards for the pocket tape packaging may dictate that a length of the pocket tape at the beginning and end of the pick-up reel be left empty. For example, the pocket 315F is shown empty with no electrical contact therein.

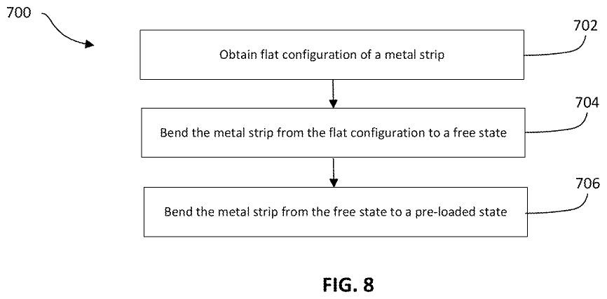

Turning now to FIG. 8, an example flowchart outlining a process 700 for manufacturing the electrical contact 100 is shown, in accordance with some embodiments of the present disclosure. At operation 702, a metal strip of a stamping progression (e.g., the stamping progression 300) may be inserted into a progressive stamping die. The progressive stamping die may include one or more stations, with each station performing one or more operations in forming the electrical contact 100. In some embodiments, the stamping may be produced by a 3D printing process. In other embodiments, the stamping may be produced by other mechanisms. At the operation 702, the metal strip may be stamped to obtain a flat configuration of the electrical contact 100, as shown in the stamping stages 500A and 500B above. At operation 704, one or more bending operations are performed to bend, fold, deform, or otherwise mold the metal strip from the flat configuration to a free state, as shown in the stamping stages 500A and 500B. The one or more bending operations may define the first linear portion 110, the first bend portion 113, the second bend portion 122, the second linear portion 130, the base 120, the third bend portion 131, the third linear portion 132, the fourth bend portion 133, the fourth linear portion 134, the fifth bend portion 171, the fifth linear portion 170, the contact portion 140, the sixth linear portion 172, and the pre-load lip 173 of the electrical contact 100, as well as the various bend portions described above. In some embodiments, the bending operations(s) of the operation 704 may lead to an electrical contact in a free state. At operation 706, the electrical contact 100 is further bent to the pre-load state, as discussed above, of FIG. 1.

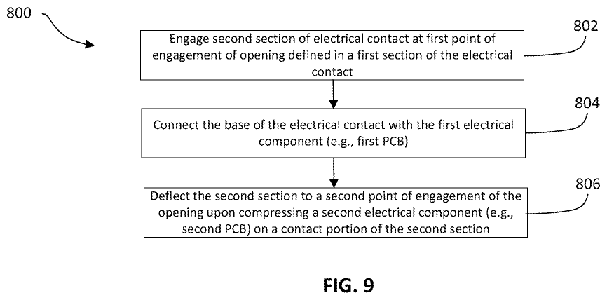

Turning now to FIG. 9, an example flowchart outlining a process 800 for using the electrical contact 100 to electrically connect a first electrical component (e.g., the first PCB 20) and a second electrical component (e.g., the second PCB 30) is shown, in accordance with some embodiments of the present disclosure. At operation 802, the electrical contact 100 may be engaged in a pre-loaded state from a free state. The pre-loaded state of the electrical contact 100 is shown in FIG. 1. In the pre-loaded state, the second section 107 electrical contact 100 is engaged with the first section 105 of the electrical contact. Specifically, in some embodiments, and as discussed above, to engage the electrical contact 100 in the pre-loaded state, the pre-load lip 173 of the second section 107 is engaged within the opening 111 defined in the first linear portion 110 of the first section 105. In some embodiments, the engagement of the pre-load lip 173 with the opening 111 in the pre-load state may be at a first point of engagement. In some embodiments, the first point of engagement may include engagement (e.g., contact, proximate, abutting, etc.) with the edge 112 of the opening 111. In some embodiments, the design (e.g., the configuration of the various linear portions and bend portions) of the electrical contact 100 may provide a first amount of pre-set force to maintain the pre-load lip 173 in engagement with the opening 111 in the pre-load state at the first point of engagement. In other embodiments, the first point of engagement may include another engagement point within the opening 111.

At operation 804, the first electrical component (e.g., the first PCB 20) may be connected to the electrical contact 100. In some embodiments and as shown in FIG. 3, the base 120 of the electrical contact 100 may be connected to the first electrical component (e.g., the first PCB 20). In some embodiments, the operation 804 may be performed before the operation 802. Upon connecting the first electrical component (e.g., the first PCB 20) to the electrical contact 100, at operation 806, the second electrical component (e.g., the second PCB 30) may be electrically connected to the electrical contact. In some embodiments, to electrically connect the second electrical component (e.g., the second PCB 30), the second electrical component may be placed over the contact portion 140. Upon applying a compression force on the second electrical component (e.g., the second PCB 30) and the contact portion 140 towards the base 120 of the electrical contact 100, the pre-load lip 173 may deflect into the opening 111 from the first point of engagement to a second point of engagement to obtain a loaded state shown in FIG. 4. In some embodiments, the second point of engagement may be further towards the base 120 compared to the first point of engagement. The design of the electrical contact 100 may exert a second amount of pre-set force to maintain the pre-load lip 173 in engagement with the opening 111 at the second point of engagement to electrically connect the second electrical component (e.g., the second PCB 30) with the first electrical component (e.g., the first PCB 20).

Thus, the present disclosure provides an electrical contact that may be used to electrically contact two electrical components (e.g., PCBs) to provide a single current line connection between the electrical components. The electrical contact may be composed from a single piece of stamping and may be provided in a pocket tape configuration for ease of use and transportation. In some embodiments, the electrical contact or portions thereof may be disposed in a housing.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.) It will be further understood by those skilled in the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.) In instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.) It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. An electrical contact comprising:
a base having a first edge and a second edge opposite the first edge, wherein the base is configured to electrically connect with a first electrical component;
a first section extending from the first edge; and
a second section extending from the second edge and comprising a contact portion to electrically connect with a second electrical component, wherein the second section further comprises a pre-load shelf configured to engage with the first section to electrically connect the first electrical component to the second electrical component.

2. The electrical contact of claim 1, wherein the first section comprises an opening, and wherein the second section is configured to engage with the opening to electrically connect the first electrical component to the second electrical component.

3. The electrical contact of claim 2, wherein the pre-load shelf of the second section comprises a pre-load lip, and wherein the pre-load lip is configured to engage with the opening.

4. The electrical contact of claim 3, wherein the pre-load lip is configured to engage with the opening at a first point of engagement before the second electrical component is electrically connected with the contact portion, and wherein the pre-load lip is configured to engage with the opening at a second point of engagement after the second electrical component is electrically connected with the contact portion.

5. The electrical contact of claim 1, wherein the pre-load shelf is spaced apart from the base and extends substantially parallel to the base.

6. The electrical contact of claim 1, wherein each of the first electrical component and the second electrical component is a printed circuit board.

7. The electrical contact of claim 1, wherein the base, the first section, and the second section are constructed from a single sheet of stamped metal.

8. The electrical contact of claim 1, wherein the contact portion is substantially U-shaped.

9. The electrical contact of claim 1, wherein a distance between the pre-load shelf and the base is less than a distance between the contact portion and the base.

10. The electrical contact of claim 1, wherein the second section comprises at least one linear portion and at least one bend portion between the base and the contact portion, and wherein the second section further comprises at least one additional linear portion and at least one additional bend portion between the contact portion and the pre-load shelf.

11. An electrical contact comprising:
a base having a first edge and a second edge opposite the first edge, wherein the base is configured to electrically connect with a first electrical component;
a first bend portion extending from the first edge;
a first linear portion extending from the first bend portion, wherein the first linear portion comprises an opening;
a second bend portion extending from the second edge;
a second linear portion extending from the second bend portion;
a contact portion connected to the second linear portion and configured to electrically connect with a second electrical component; and
a pre-load shelf connected to the contact portion and configured to engage with the opening of the first linear portion to electrically connect the first electrical component to the second electrical component.

12. The electrical contact of claim 11, wherein the second linear portion is substantially parallel to the first linear portion.

13. The electrical contact of claim 11, further comprising:
a third bend portion extending from the second linear portion;
a third linear portion extending from the third bend portion;
a fourth bend portion extending from the third linear portion; and
a fourth linear portion extending from the fourth bend portion,
wherein the contact portion extends from the fourth linear portion.

14. The electrical contact of claim 13, wherein the third linear portion is substantially parallel to the base and the pre-load shelf, and wherein the fourth linear portion is substantially parallel to the first linear portion and the second linear portion.

15. The electrical contact of claim 13, wherein a distance between the base and the pre-load shelf is less than a distance between the third linear portion and the base, and wherein the distance between the third linear portion and the base is less than a distance between the contact portion and the base.

16. The electrical contact of claim 13, further comprising:
a fifth bend portion extending from the pre-load shelf; and
a fifth linear portion extending from the fifth bend portion to the contact portion.

17. The electrical contact of claim 11, wherein the pre-load shelf comprises a pre-load lip configured to engage with the opening, wherein the pre-load lip is configured to engage with the opening at a first point of engagement before the second electrical component is electrically connected with the contact portion, and wherein the pre-load lip is configured to engage with the opening at a second point of engagement after the second electrical component is electrically connected with the contact portion.

18. A method comprising:
engaging a second section of an electrical contact at a first point of engagement of an opening defined in a first section of the electrical contact, wherein the first section extends from a first edge of a base of the electrical contact and the second section extends from a second edge of the base;
connecting the base with a first electrical component; and
deflecting the second section to a second point of engagement of the opening upon compressing a second electrical component on a contact portion of the second section for electrically connecting the first electrical component with the second electrical component.

19. The method of claim 18, wherein each of the first electrical component and the second electrical component is a printed circuit board.

20. The method of claim 18, wherein the second point of engagement is closer to the base than the first point of engagement.
